(19) United States
(12) Patent Application Publication
(10) Pub. No.: US 2021/0405161 A1
(43) Pub. Date: Dec. 30, 2021

(54) MECHANICALLY SCANNING LIDAR

(71) Applicant: Seagate Technology LLC, Fremont, CA (US)

(72) Inventors: Dan MOHR, St. Paul, MN (US); Kevin A. GOMEZ, Eden Prairie, MN (US); Wolfgang ROSNER, Burnsville, MN (US); Zoran JANDRIC, Minneapolis, MN (US)

(21) Appl. No.: 16/917,502

(22) Filed: Jun. 30, 2020

(51) Int. Cl. G01S 7/481; G01S 17/08

(52) U.S. Cl. CPC G01S 7/4817; G01S 7/4816; G01S 7/4815; G01S 17/08

(57) ABSTRACT

Various implementations of a LiDAR system disclosed herein include two laser sources configured to generate a first laser beam and a second laser beam, a first vertically scanning mirror configured to rotate about a first axis, a second vertically scanning mirror configured to rotate about a second axis, wherein the first axis and second axis are in the same plane and may be parallel to each other, and a polygonal mirror configured to rotate around a third axis, wherein the third axis is orthogonal to each of the first axis and the second axis, wherein the first vertical scanning mirror is configured to direct the first laser beam towards the polygonal mirror and the first vertical scanning mirror is configured to direct the first laser beam towards the polygonal mirror. Alternative implementations may include a combination of collection lenses and detectors to detect reflected laser beams.

### BACKGROUND

Light detection and ranging (LIDAR) is a technology that measures a distance to an object by projecting a laser toward the object and receiving the reflected laser. As a method of measuring a distance in the LIDAR technology, a time of flight (TOF) which uses a flight time of laser light, a triangulation method which calculates a distance according to a position of a received laser according to a position of a received laser, and the like are used. The triangulation method measures a distance with respect to a wide range at once mainly by using a flash laser, but has low accuracy, therefore LIDAR, to which the TOF method capable of performing relatively high definition/high resolution measurement with respect to a long distance, is used as a distance sensor for autonomous vehicles which have recently taken center stage as a significant application field for LIDAR.

### SUMMARY

This summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the claimed subject matter will be apparent from the following, more particular written Detailed Description of various implementations as further illustrated in the accompanying drawings and defined in the appended claims.

Various implementations of a LiDAR system disclosed herein include two laser sources configured to generate a first laser beam and a second laser beam, a first vertically scanning mirror configured to rotate about a first axis, a second vertically scanning mirror configured to rotate about a second axis, wherein the first axis and second axis are parallel to each other, and a polygonal mirror configured to rotate around a third axis, wherein the third axis is orthogonal to each of the first axis and the second axis, wherein the first vertical scanning mirror is configured to direct the first laser beam towards the polygonal mirror and the first vertical scanning mirror is configured to direct the first laser beam towards the polygonal mirror.

These and various other features and advantages will be apparent from a reading of the following Detailed Description.

### BRIEF DESCRIPTIONS OF THE DRAWINGS

A further understanding of the nature and advantages of the present technology may be realized by reference to the figures, which are described in the remaining portion of the specification.

FIG. 1 discloses an example configuration of a mechanically scanning mirror including a polygonal rotating scanning mirror.

FIG. 2 discloses an alternative example configuration of a mechanically scanning mirror including a polygonal rotating scanning mirror.

FIG. 3 discloses yet another example configuration of a mechanically scanning mirror including a polygonal rotating scanning mirror.

FIG. 4 discloses an alternative example configuration of a mechanically scanning mirror including a polygonal rotating scanning mirror.

FIG. 5 discloses yet another example configuration of a mechanically scanning mirror including a polygonal rotating scanning mirror.

FIG. 6 illustrates an example configuration of semi-conductor lasers used in the LIDAR system disclosed herein.

FIG. 7 discloses an alternative example configuration of a mechanically scanning mirror including a polygonal rotating scanning mirror.

FIG. 8 illustrates an example configuration of a mechanically scanning mirror including a two-sided flat rotating scanning mirror.

### DETAILED DESCRIPTION

In mechanically scanning LiDAR for automotive applications, achieving large detection range, field of view, high density scanning, and low cost is not trivial. The design of the mechanically scanning LiDAR disclosed herein allows for the use of simple and few components alongside a large collection aperture to meet all the above metrics. Additionally, the design is quite compact, in the sense that much of the cross-sectional area is well-utilized.

One or more implementations disclosed herein provide mechanically scanning LiDARs of two laser emitters, two optical detectors, two collection lenses, two vertically scanning mirrors, and one horizontally rotating mirror. In one implementation, each laser is directed into the scanning mirrors, leading it to raster across a field of view as the mirrors articulate. Objects which reflect light in the field of view bounce scattered light back towards the device, which are de-scanned by reflection off the same scanning mirrors in reverse order, and then collected and focused down to the detector via the collection lens. By relating the generation of light at the laser to the time it was received by the detector, the mechanically scanning LiDAR allows users to estimate the distance of the object in the field of view. Repeating this over different mirror positions allows users to build map surrounding environment in 3D fashion.

Two-dimensional mechanically scanning LiDAR at large scanning field-of-views with high frame rates, large scanning densities, long range, and eye-safe are typically difficult to achieve. The disclosed mechanically scanning LiDAR overcome the normal obstacles of using expensive galvanometer mirrors or many laser emitters and detectors by incorporating a fast rotational mirror, and a cheap, slow vertically scanning mirror. Having two passive optical mirrors allows the mechanically scanning radars to cut the number of laser emitters and detectors to two of each. The operational simplicity of the mirrors also allows for cheap manufacture and reliable design. Furthermore, the optical components of the mechanically scanning LiDAR disclosed herein are placed in a compact design to facilitate integration into larger systems. As opposed to a micro electromechanical system (MEMS) based or other small-aperture based scanning systems, the mechanically scanning LiDARs disclosed herein allows for a large collection aperture, thus enabling long range. While this mechanically scanning LiDAR disclosed herein can be scaled arbitrarily, in one implementation, the mechanically scanning LiDARs disclosed herein have an aperture of approximate 1-5 cm\hat{ }2, however wider apertures may be provided in alternative implementations.

The technology disclosed herein provides various implementations of mechanically scanning LiDAR. One implementations of such mechanically scanning LiDAR includes a rotationally-scanning mirror, two vertically scanning mirrors, a laser source, a collection lens, and a detector. For the following figures elements that are configured in substantial symmetry, such symmetric components are referred to by “a” and “b” with respect to the reference numeral. When referred to such symmetric components together, the reference numeral is used to refer to both of such symmetric components. Thus, for example, laser sources 110a and 110b may be referred to together as laser sources 110, detectors 112a and 112b may be referred to together as detectors 112, etc.

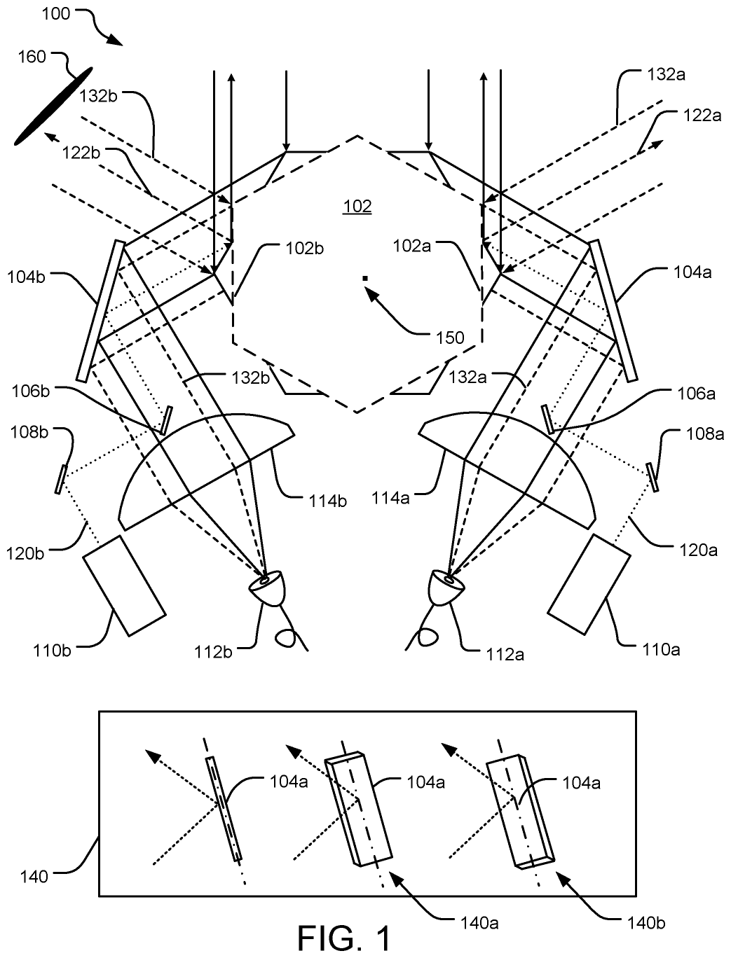

FIG. 1 discloses an example configuration of a mechanically scanning LiDAR 100 including a polygonal rotating scanning mirror 102. The mode of operation of the mechanically scanning LiDAR 100 is as follows: Laser sources 110 emit light beam 120, which may be pulsed or continuous. The light beam 120 is reflected by auxiliary mirrors 108 and 106 towards vertically scanning mirrors 104 (also referred to as “galvo mirrors 104”). The vertically scanning mirrors 104 rotate about an axis or rotation that is the plane of the page of FIG. 1. Example rotation of the mirror 104a around an axis in the plane of the page is illustrated at 140. Specifically, at 140a, the mirror 104a is rotated counter-clockwise around the axis whereas at 140b, the mirror 104a is rotated clockwise around the axis.

After reflection from the vertical scanning mirrors 104, the light beam 120 then bounces off the rotationally scanning mirror 102. The rotationally scanning mirror 102 may be in the shape of a polygon with n sides. In FIG. 1, the rotationally scanning mirror 102 is a hexagon with six sides 102a, 102b, etc. In alternative implementations, the rotationally scanning mirror 102 may be a 3-, 4-, 5-, or 7-sided polygonal mirror. The rotationally scanning mirror 102 may rotate around an axis 150 that is into the page of FIG. 1. Thus, the axis 150 of the rotationally scanning mirror 102 is orthogonal to the axis 140 of the galvo mirrors 104. As the rotationally scanning mirror 102 rotates, the angle of reflection changes dependent on the angle of the rotation scanning mirror. Thus, the rotationally scanning mirror 102 effectively scans the light beam 120 horizontally in the plane of the page of FIG. 1, while the vertically scanning mirrors 104 effectively scans the light beam 120 vertically out of the page. However, when the full vector ray tracing is performed, a small component of the light beam 120 from the vertical scanning mirror 104 is scanned within the page (horizontally).

Due to contributions of both mirrors, the laser light beam therefore scans in two largely independent dimensions, allowing for a raster scan across the field of view of the mechanically scanning LiDAR 100. The light beam 120 reflected from the rotationally scanning mirror 102 is shown by 122, which after colliding with an object 160 may back scatter towards the mechanically scanning LiDAR 100. The back scattered light beam 132 reflects off of the rotationally scanning mirror 102 and the galvo mirror 104 towards collection lens 114. The collection lens 114 focuses the backscattered light beam 132 towards a detector 112. Note that the detector 112 may be one of a single element detector or a multiple element detector.

The rotationally scanning mirror 102 maybe rotating at a speed in the range of 10 to 30 revolutions per minute (RPM). On the other hand, the galvo mirror 104 may rotate at similar speed, however, it does not revolve completely around its axis. Assuming that not too much time has passed, the backscattered light beam 132 which makes it to the mechanically scanning LiDAR 100 then reflects off the rotationally scanning mirror 102, followed by the vertically scanning mirror 104, and eventually travels through the collection lens 114. In the implementation disclosed in FIG. 1, two optical scanning and detection modules are present, except for the rotationally scanning mirror 102, which is shared by each of the two optical scanning and detection modules.

It is understood that the actual implementation of the mechanically scanning LiDAR 100 need not fit the precise geometric configuration as pictured in FIG. 1. In alternative implementations, the angles and component arrangements may be different than that disclosed in FIG. 1.

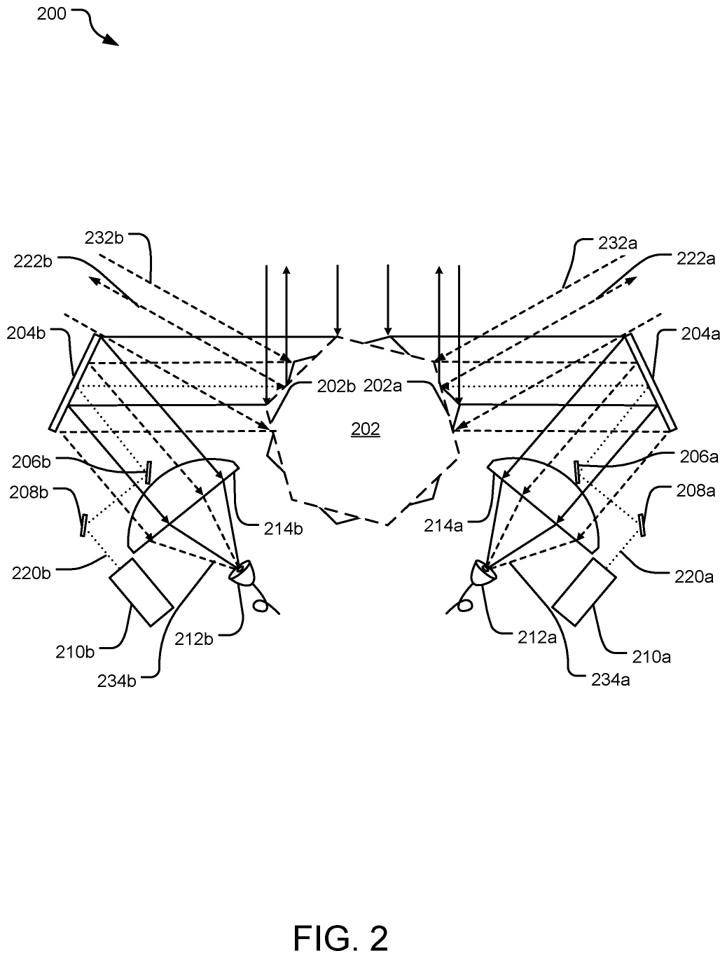

FIG. 2 discloses an alternative configuration of a mechanically scanning LiDAR 200 including a polygonal rotating scanning mirror 202. As compared to FIG. 1, the placement of galvo mirrors 204 and therefore the angle at which it reflects a light beam 220 onto the rotating scanning mirror 202 is different. The configuration and functionality of other components of FIG. 2, including laser sources 210 that emit light beam 220, the auxiliary mirrors 206, 208, the outgoing beam 222, the backscattered beam 232, the collection lens 214, and the detectors 212 are substantially similar to those of FIG. 1.

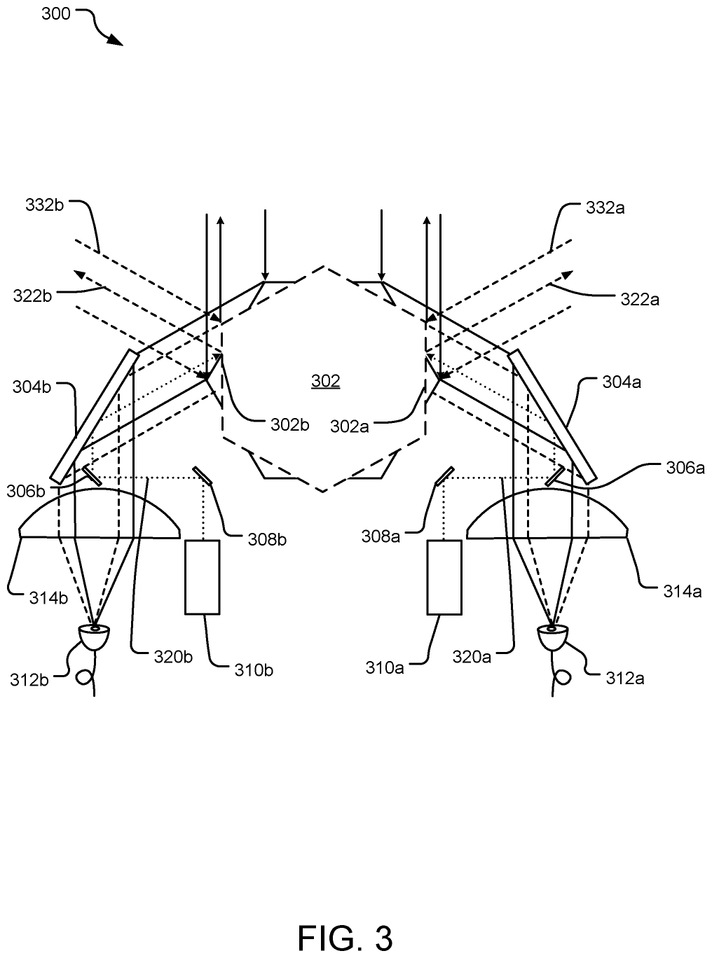

FIG. 3 discloses an alternative configuration of a mechanically scanning LiDAR 300 including a polygonal rotating scanning mirror 302. Here the position of the laser sources 310 is different compared to that in FIG. 1 and FIG. 2. The configuration and functionality of other components of FIG. 3, including laser sources 310 that emit light beam 320, the auxiliary mirrors 306, 308, the outgoing beam 322, the backscattered beam 332, the collection lens 314, and the detectors 312 are substantially similar to those of FIG. 1.

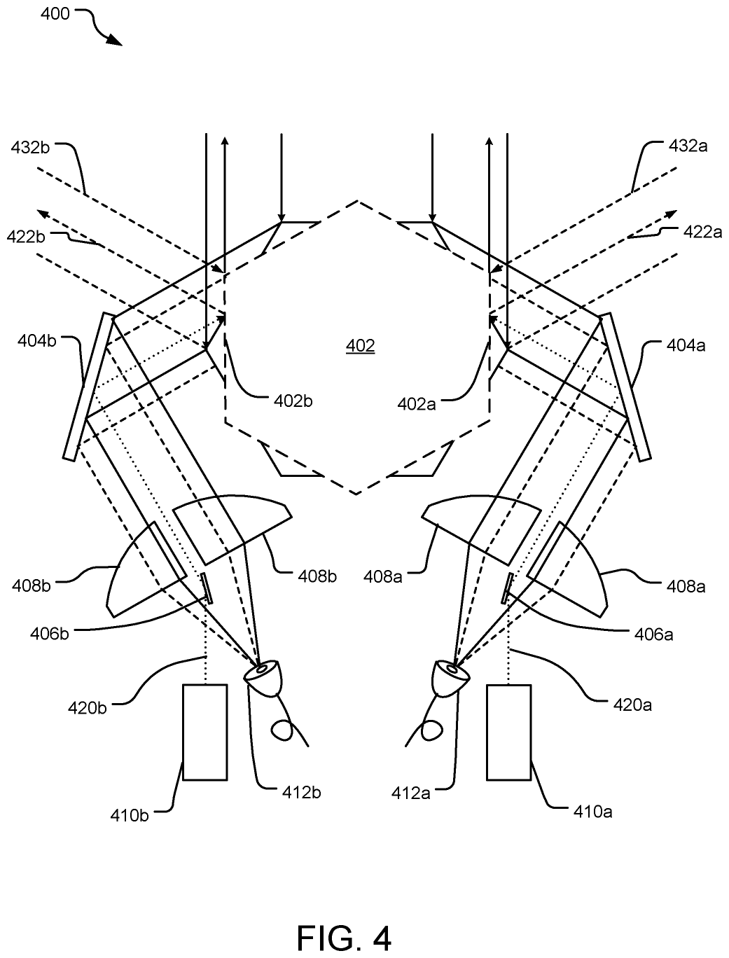

FIG. 4 discloses an alternative configuration of a mechanically scanning LiDAR 400 including a polygonal rotating scanning mirror 402. The configuration here indicates that the configuration of the laser with respect to the collection lens/detector assembly need not be so rigid. Specifically, in FIG. 4, the laser sources 410 may be oriented well off the optical axis of the detector 412/collection lens 408 pair. Additionally, any number of auxiliary mirrors may be used. For example, in FIG. 4, only one auxiliary mirror pair 406 is used to reflect light beam 420 towards the servo mirrors 404.

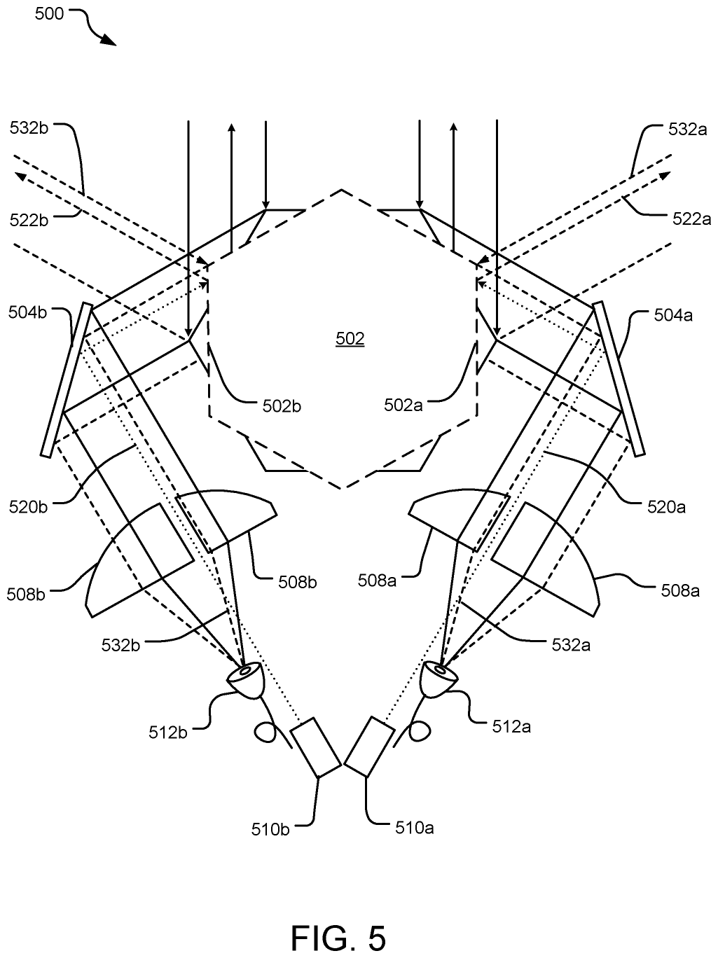

FIG. 5 discloses an alternative configuration of a mechanically scanning LiDAR 500 including a polygonal rotating scanning mirror 502. Specifically, in this configuration, there are no auxiliary mirrors, compared to one auxiliary mirror pair in FIG. 4 and two auxiliary mirror pair in FIGS. 1, 2, and 3.

In one or more of the implementations disclosed above, the laser sources and the detector/collection lens pair are roughly aligned or imaged (via auxiliary mirrors) into the same optical axis. However, this can happen after the collection lens as shown in FIGS. 1, 2, 3, before the collection lens as shown in FIGS. 4 and 5, or within the collection lens (not shown). Yet alternatively, the auxiliary mirror 406 in FIG. 4 may be placed within the lens 408. Yet alternatively, the laser sources may be combined with the collection lenses.

Furthermore, a number of alternative mechanical enumerations may be used. For example, the auxiliary mirrors could be mechanically combined with the laser, the auxiliary mirrors could be mechanically combined into the collection lens, and the laser could be mechanically combined into the collection lens. Yet alternatively, the form of the laser beam (such as 120, 220, etc.) may also vary in alternative implementations. For example, the laser sources 110, 210, etc., may be semiconductor laser source with single mode, multi-mode, or multi-emitter, a fiber laser, a diode-pumped solid state (DPSS) laser, an optically pumped surface-emitting laser (OPSEL), etc.

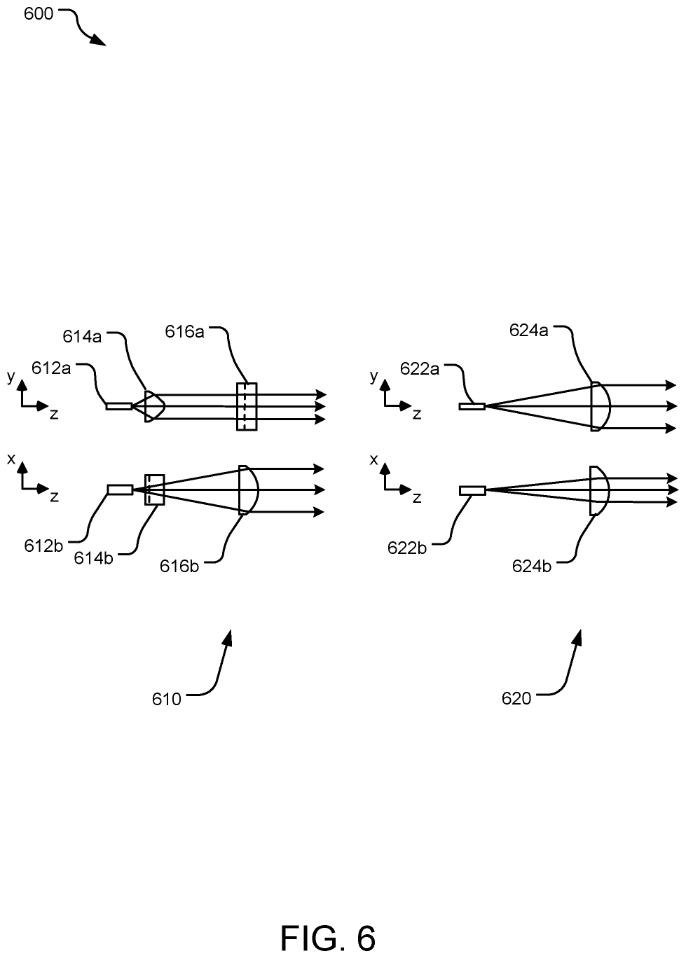

FIG. 6 illustrates an example configurations of semi-conductor lasers used in the LIDAR system disclosed herein. Specifically, the case of 610 depicts laser light emanating from a semiconductor die 612 through two collimation lenses 614 and 616, each acting on only one axis of diverging light. The case of 620 represents the use of only one collimation lens 624 for the laser light emanating from a semiconductor die 622. In alternative implementations, a multiple lens collimation assembly comprised of any number of lenses may be used. Lasers such as DPSS and OPSEL lasers may even forgo a lens due to the large cavity cross-sectional area available, decreasing the native beam divergence.

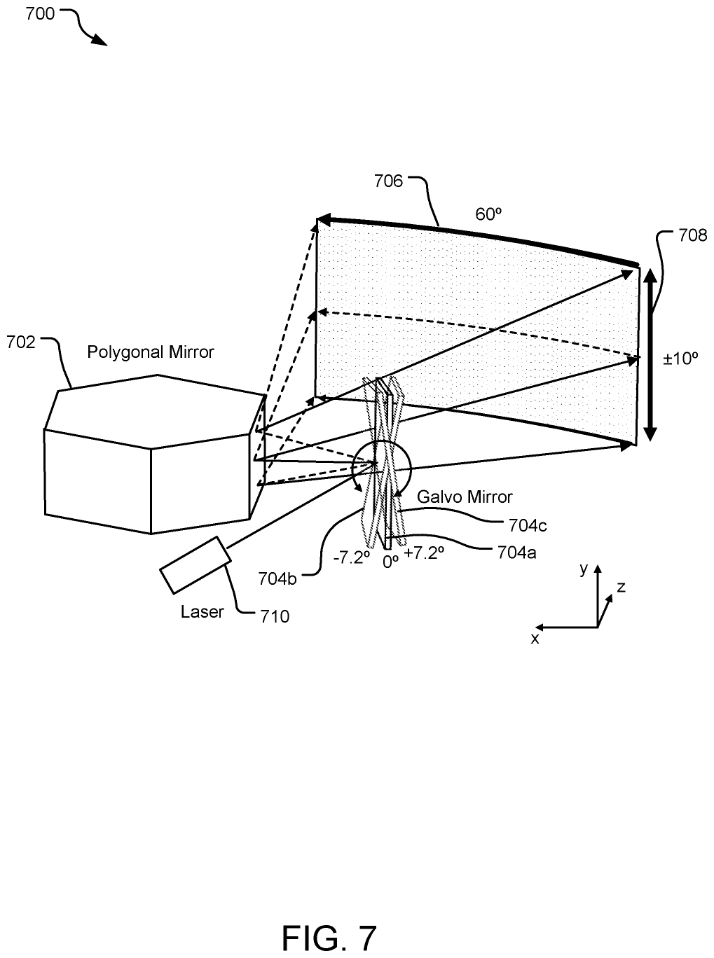

FIG. 7 discloses an alternative example configuration of a mechanically scanning LiDAR 700 including a polygonal rotating scanning mirror 702 in three-dimensions (3D). Specifically, the illustrated implementation includes a laser source 720 generating a light beam that is reflected by a galvo mirror 704 (shown in different positions 704a, 704b, 704c) that direct the light beam to the rotating scanning mirror 702 to generate a horizontal scanning range 706 of approximately 60 degrees and a vertical scanning range 708 of approximately ±10 degrees.

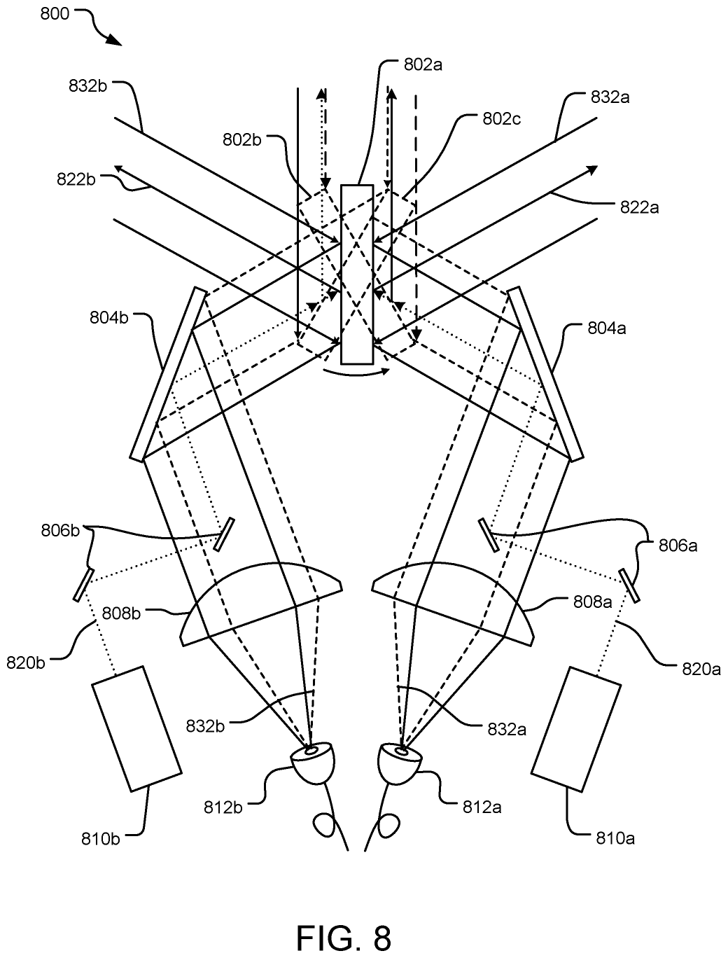

FIG. 8 illustrates an example configuration of a mechanically scanning LIDAR 800 including a two-sided flat rotating scanning mirror 802 (shown in different positions 802a, 802b, 802c). One or more of the other components (laser sources 810, the light beams 820, the auxiliary mirrors 806, the galvo mirrors 804, the collection lens 808, the detector 812, etc.) and their configurations in FIG. 8 may be substantially similar to those disclosed in one or more of FIGS. 1-6.

The above specification, examples, and data provide a complete description of the structure and use of example embodiments of the disclosed technology. Since many embodiments of the disclosed technology can be made without departing from the spirit and scope of the disclosed technology, the disclosed technology resides in the claims hereinafter appended. Furthermore, structural features of the different embodiments may be combined in yet another embodiment without departing from the recited claims.

What is claimed is:

1. A system comprising:
two laser sources configured to generate a first laser beam and a second laser beam;
a first vertically scanning mirror configured to rotate about a first axis;
a second vertically scanning mirror configured to rotate about a second axis, wherein the first axis and second axis are in the same plane; and
a polygonal mirror configured to rotate around a third axis, wherein the third axis is orthogonal to each of the first axis and the second axis,
wherein the first vertical scanning mirror is configured to direct the first laser beam towards the polygonal mirror and the second vertical scanning mirror is configured to direct the second laser beam towards the polygonal mirror.

2. The system of claim 1, wherein the first axis and second axis are parallel to each other.

3. The system of claim 1, wherein the first vertical scanning mirror and the second vertical scanning mirror are configured symmetrically on opposites sides of a design symmetry plane.

4. The system of claim 1, wherein the polygonal mirror is a hexagonal mirror.

5. The system of claim 1, wherein the polygonal mirror is a flat mirror with two sides.

6. The system of claim 1, further comprising:
a first collection lens configured to receive a first reflected laser beam from a target via the polygonal mirror and the first vertically scanning mirror; and
a second collection lens configured to receive a second reflected laser beam from the target via the polygonal mirror and the second vertically scanning mirror.

7. The system of claim 5, further comprising:
a first set of intervening mirrors configured to direct the first laser beam towards the first vertically scanning mirror; and
a second set of intervening mirrors configured to direct the second laser beam towards the second vertically scanning mirror.

8. The system of claim 5, further comprising:
a first detector configured to detect the first reflected laser beam from the first collection lens; and
a second detector configured to detect the second reflected laser beam from the second collection lens.

9. The system of claim 7, wherein
the first collection lens is configured to pass the first laser beam substantially through its center; and
the second collection lens is configured to pass the second laser beam substantially through its center.

10. A system comprising:
one or more laser sources configured to generate one or more laser beams;
one or more vertically scanning mirrors, each of the one or more vertically scanning mirrors configured to rotate about one or more axis, each of the one or more axis being in the same plane with each other; and
a polygonal mirror configured to rotate around a polygonal mirror axis, wherein the polygonal mirror axis is orthogonal to each of the one or more axis of the vertically scanning mirrors,
wherein each of the one or more vertically scanning mirrors is configured to direct one of the one or more laser beams towards the polygonal mirror.

11. The system of claim 9, wherein the first vertical scanning mirror and the second vertical scanning mirror are configured symmetrically on opposites sides of the third axis.

12. The system of claim 9 wherein the polygonal mirror is a hexagonal mirror.

13. The system of claim 9, wherein the polygonal mirror is a flat mirror with two sides.

14. The system of claim 9, further comprising:
a first collection lens configured to receive a first reflected laser beam from a target via the polygonal mirror and the first vertically scanning mirror; and
a second collection lens configured to receive a second reflected laser beam from the target via the polygonal mirror and the second vertically scanning mirror.

15. The system of claim 13, further comprising:
a first set of intervening mirrors configured to direct the first laser beam towards the first vertically scanning mirror; and
a second set of intervening mirrors configured to direct the second laser beam towards the second vertically scanning mirror.

16. The system of claim 13, further comprising:
a first detector configured to detect the first reflected laser beam from the first collection lens; and
a second detector configured to detect the second reflected laser beam from the second collection lens.

17. A method, comprising:
generating a first laser beam and a second laser beam; and
projecting the first laser beam on a first vertically scanning mirror configured to rotate about a first axis;
projecting the second laser beam on a second vertically scanning mirror configured to rotate about a second axis; and
reflecting each of the first laser beam from the first vertically scanning mirror and the second laser beam from the second vertically scanning mirror towards a polygonal mirror configured to rotate around a third axis, wherein the third axis is orthogonal to each of the first axis and the second axis.

18. The method of claim 16, wherein the first vertical scanning mirror and the second vertical scanning mirror are configured symmetrically on opposites sides of the third axis.

19. The method of claim 16, wherein the polygonal mirror a 2-, 3-, 4-, 5-, 6-, or a 7-sided mirror.

20. The method of claim 16, wherein the first vertical scanning mirror and the second vertical scanning mirror are configured symmetrically on opposites sides of the third axis.
